(19) United States
(12) Patent Application Publication
(10) Pub. No.: US 2018/0145440 A1
(43) Pub. Date: May 24, 2018

(54) PLUG CONNECTOR ASSEMBLY HAVING IMPROVED CONTACTING MODULE STRUCTURE

(71) Applicant: FOXCONN INTERCONNECT TECHNOLOGY LIMITED, Grand Cayman (KY)

(72) Inventors: JERRY WU, New Taipei, CA (US); JUN CHEN, Kunshan (CN); XIAO FAN, Kunshan (CN); ZHI-YONG ZHOU, Kunshan (CN)

(21) Appl. No.: 15/817,317

(22) Filed: Nov. 20, 2017

(30) Foreign Application Priority Data
Nov. 23, 2016 (CN) 201611040950.2

(51) Int. Cl. H01R 13/502; H01R 13/627; H01R 13/635; H01R 13/405

(52) U.S. Cl. CPC H01R 13/502; H01R 13/405; H01R 13/635; H01R 13/6273

(57) ABSTRACT

A plug connector assembly includes a cable and a mating member electrically connected to the cable, the mating member having an insulative housing and a contacting module retained in the insulative housing, the contacting module having a first contacting module unit and a second contacting module unit, the first contacting module unit having plural first contacts arranged along a lateral direction and a first insulative member retaining the first contacts, the second contacting module unit having plural second contacts arranged along the lateral direction and a second insulative member retaining the second contacts, wherein each of the first and second insulative members includes a same engagement structure, through which the first insulative member and the second insulative member are assembled into a whole by interference arrangement and then inserted into the insulative housing together.

### BACKGROUND OF THE INVENTION

### 1. Field of the Invention

The present invention relates generally to a plug connector assembly and more particularly to an improved contacting module structure for easy assembly.

### 2. Description of Related Arts

U.S. Patent Application Publication No. 2015/0288104, published on Oct. 8, 2015, shows a plug connector assembly including a mating member, a cable electrically connected with the mating member, and an outer case enclosing the mating member and the cable. The mating member includes an insulative housing and a pair of contacting modules assembled in the insulative housing. The contacting modules are inserted into the insulative housing respectively. Thus, the pair of contacting modules needs to be assembled separately and needs to be aligned and installed separately, increasing the assembly process and cost.

An improved contacting module structure in a plug connector assembly is desired.

### SUMMARY OF THE INVENTION

An object of the present invention is to provide an improved contacting module having an easy assembling process and a lower cost.

To achieve the above-mentioned object, a plug connector assembly comprises: a cable; and a mating member electrically connected to the cable, the mating member including an insulative housing and a contacting module retained in the insulative housing, the insulative housing including: a mating surface defined on a front end thereof; an opposite mounting surface; a mating slot inwardly extending from the mating surface, and further including a plurality of first contacting slots arranged on a side thereof and a plurality of second contacting slots arranged on another side thereof; and a mounting slot communicating with the mating slot and inwardly extending from the mounting surface for inserting the contacting module, the contacting module including: a first contacting module and a second contacting module, the first contacting module including a plurality of first contacts arranged along a lateral direction and a first insulative member retaining the first contacts, the second contacting module including a plurality of second contacts arranged along the lateral direction and a second insulative member retaining the second contacts; wherein each of the first and second insulative members includes a same engagement structure, through which the first insulative member and the second insulative member are assembled into a whole by interference arrangement and then inserted into the insulative housing together.

### BRIEF DESCRIPTION OF THE DRAWING

FIG. 1 is a perspective view of a plug connector assembly in accordance with the present invention;

FIG. 2 is an exploded view of the plug connector assembly in FIG. 1;

FIG. 3 is an exploded view similar to FIG. 2, but from a different aspect;

FIG. 4 is an exploded view of the mating member of the plug connector assembly in FIG. 1;

FIG. 5 is an exploded view similar to FIG. 4, but from a different aspect;

FIG. 6 is a front view of the assembly of the first insulative member and the second insulative member of the plug connector assembly in FIG. 1;

FIG. 7 is a perspective view of the insulative housing, the first insulative member and the second insulative member of the plug connector assembly in FIG. 1;

FIG. 8 is a perspective view similar to FIG. 7, but from a different aspect;

FIG. 9 is a perspective view of the first contacting module and the second contacting module of the plug connector assembly in FIG. 1;

FIG. 10 is a sectional view of the plug connector assembly in FIG. 1, taken along line 10-10; and

FIG. 11 is a sectional view of the plug connector assembly in FIG. 1, taken along line 11-11.

### DETAILED DESCRIPTION OF THE PREFERRED EMBODIMENT

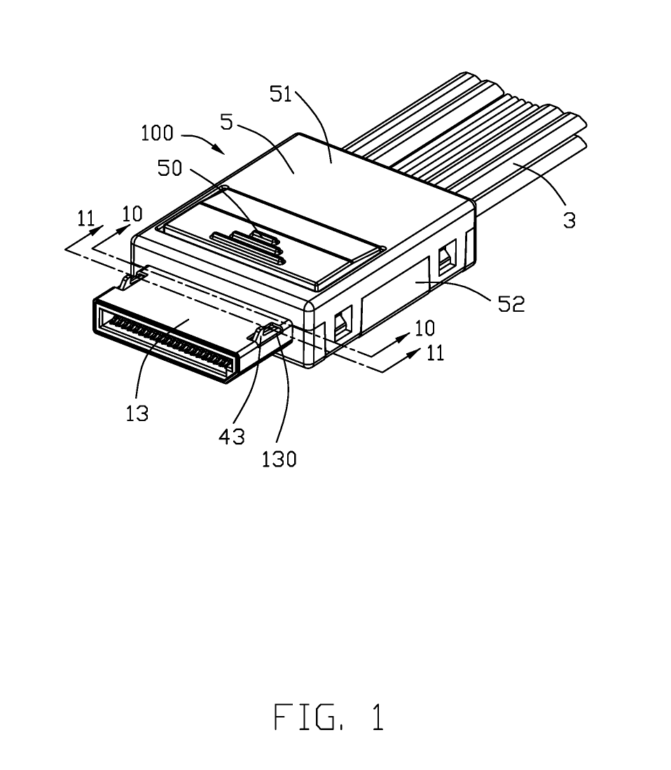

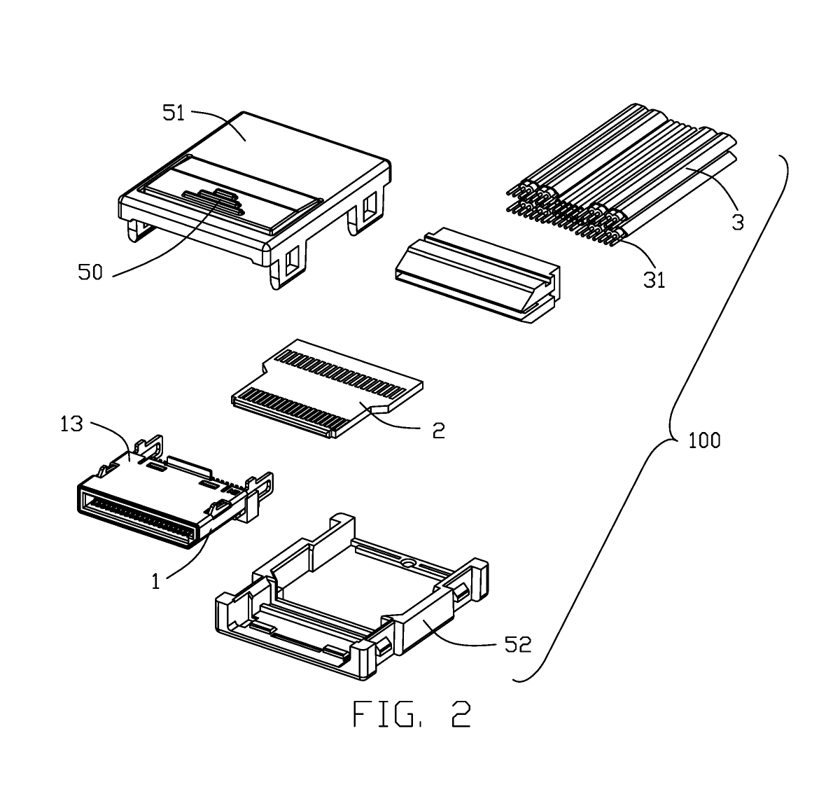

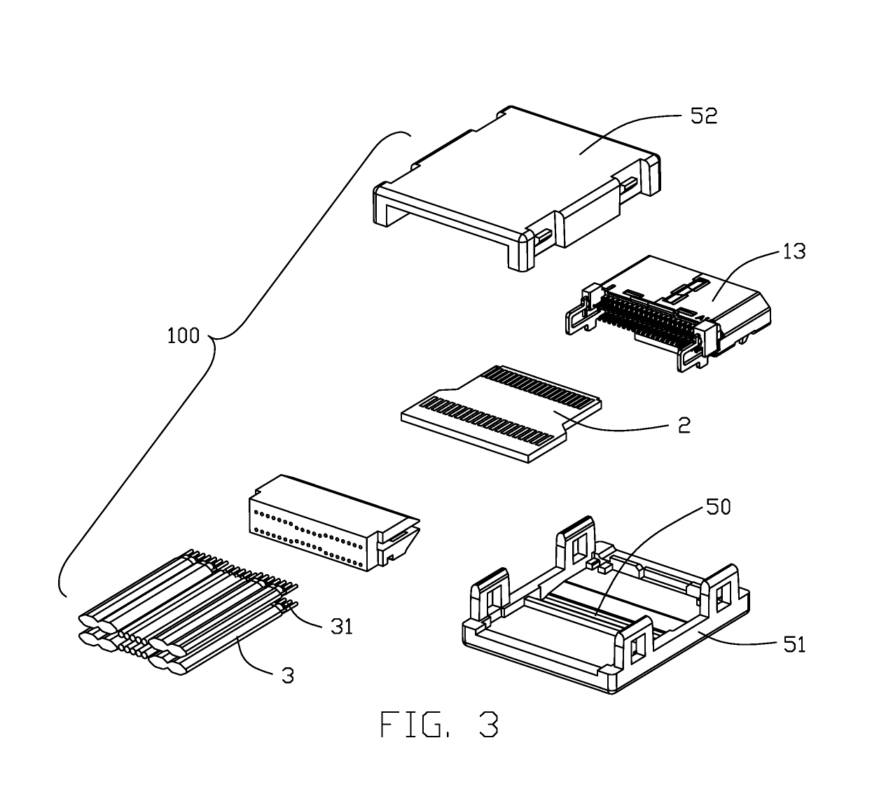

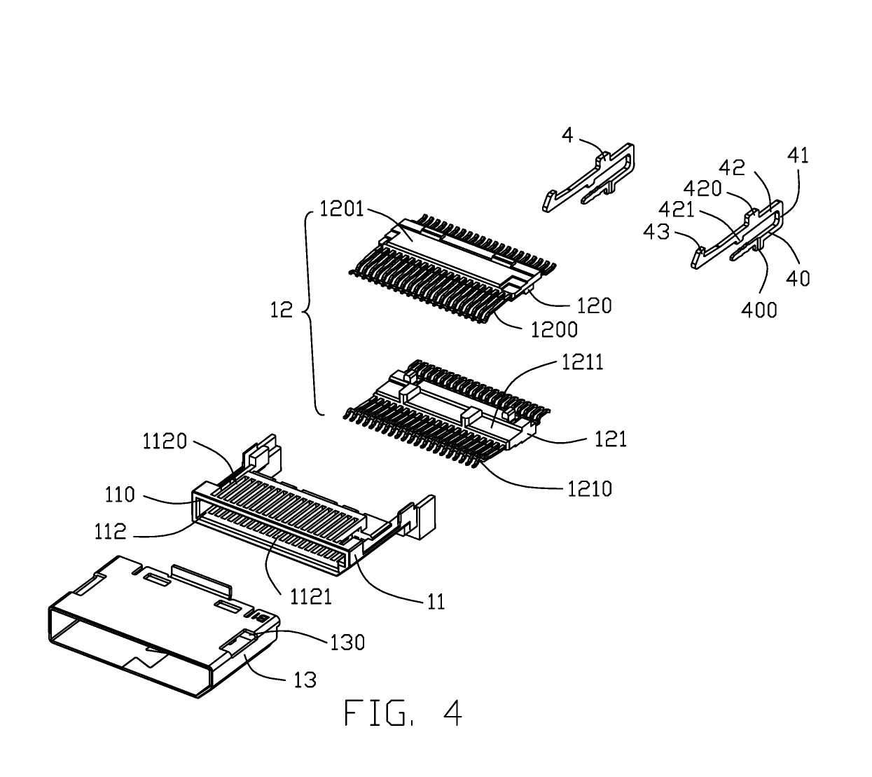

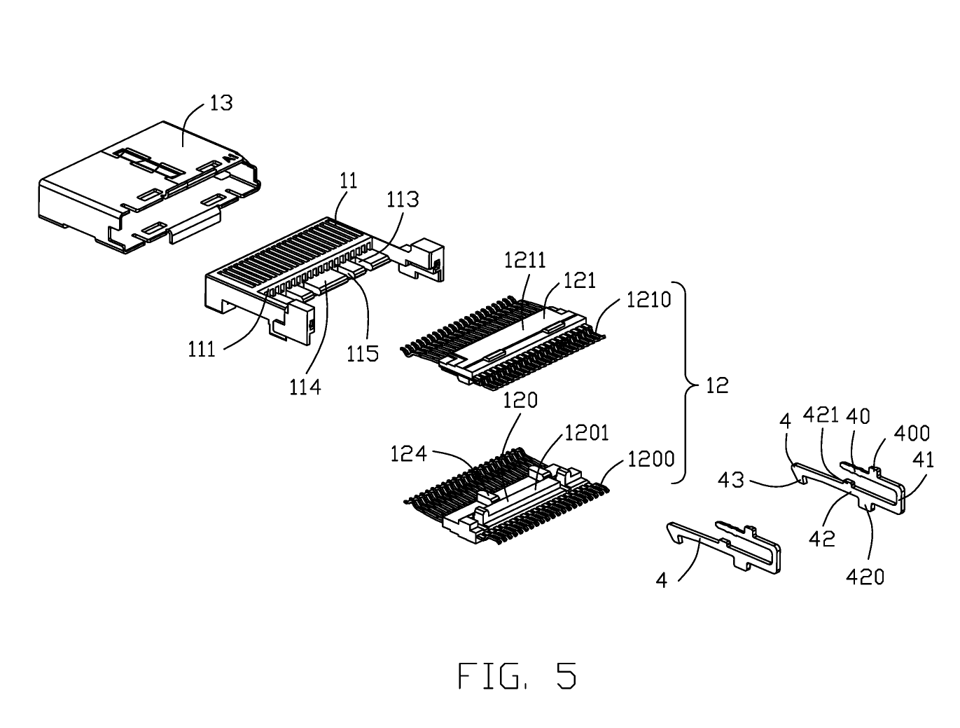

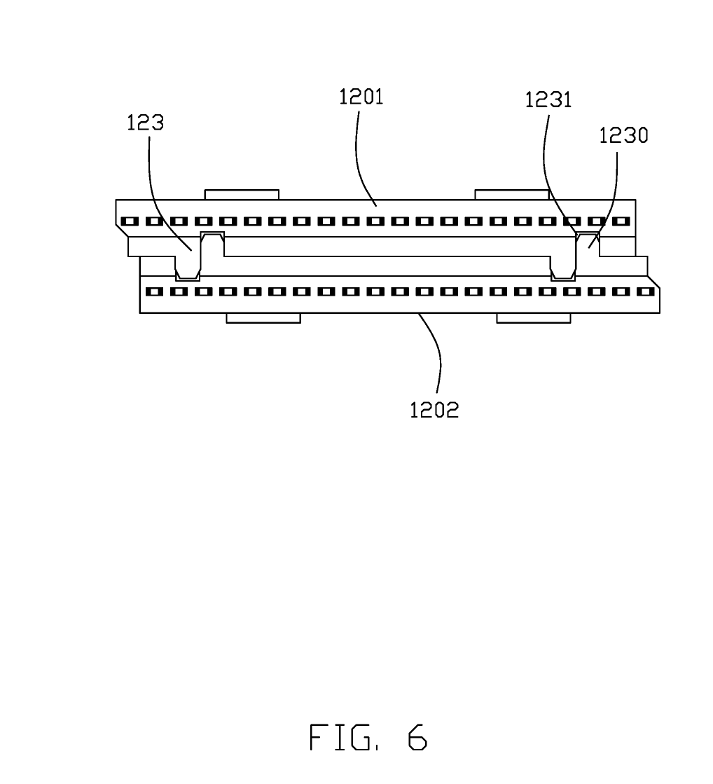

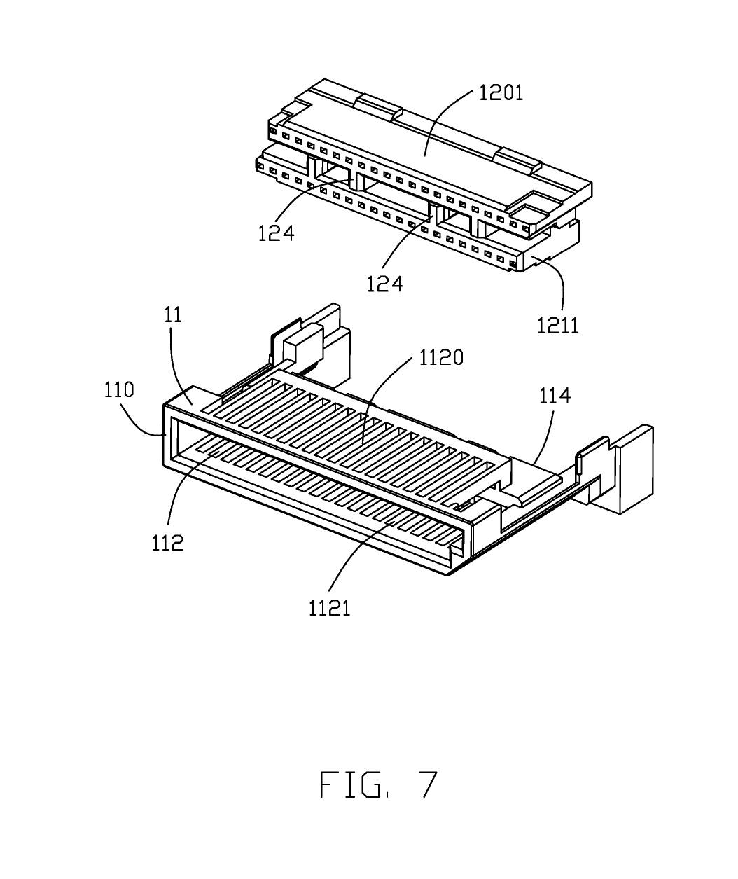

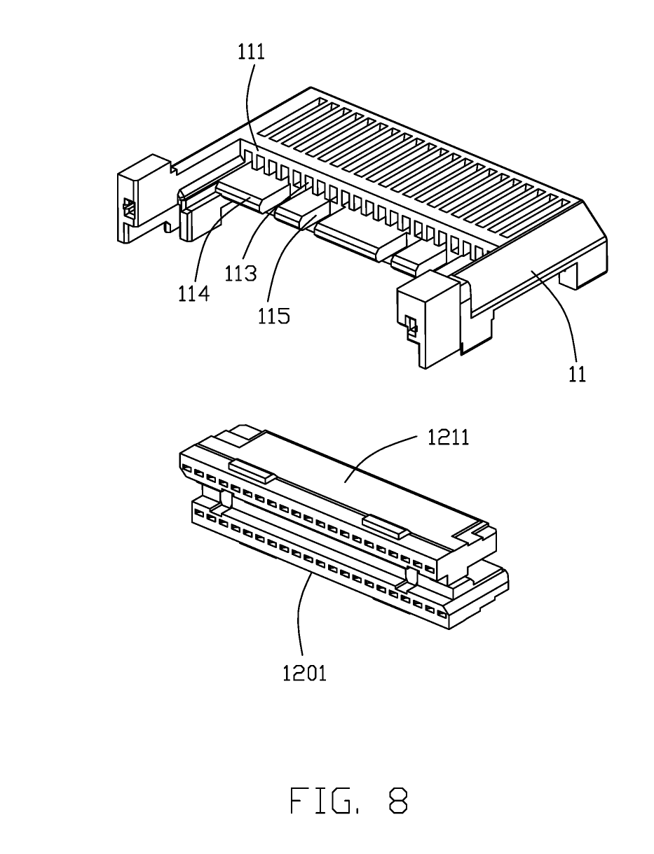

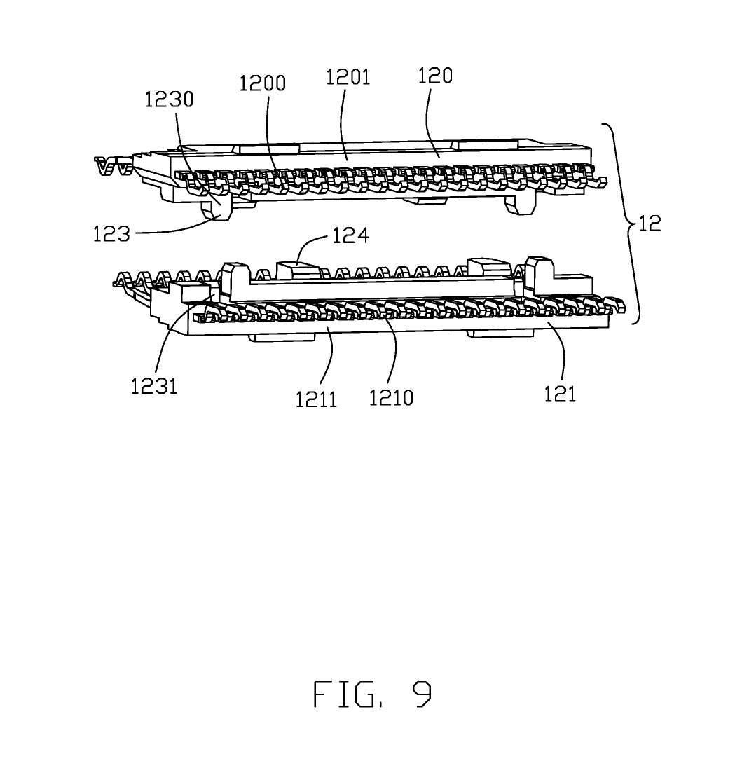

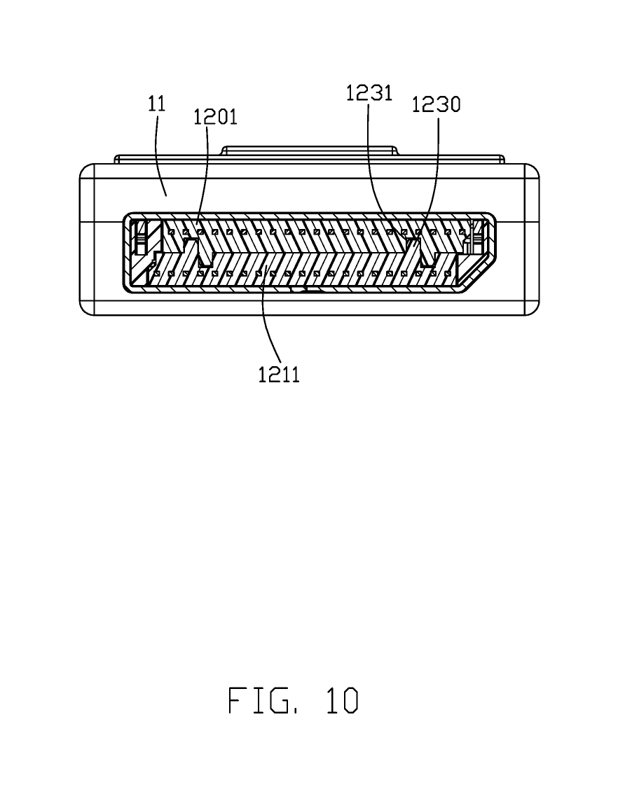

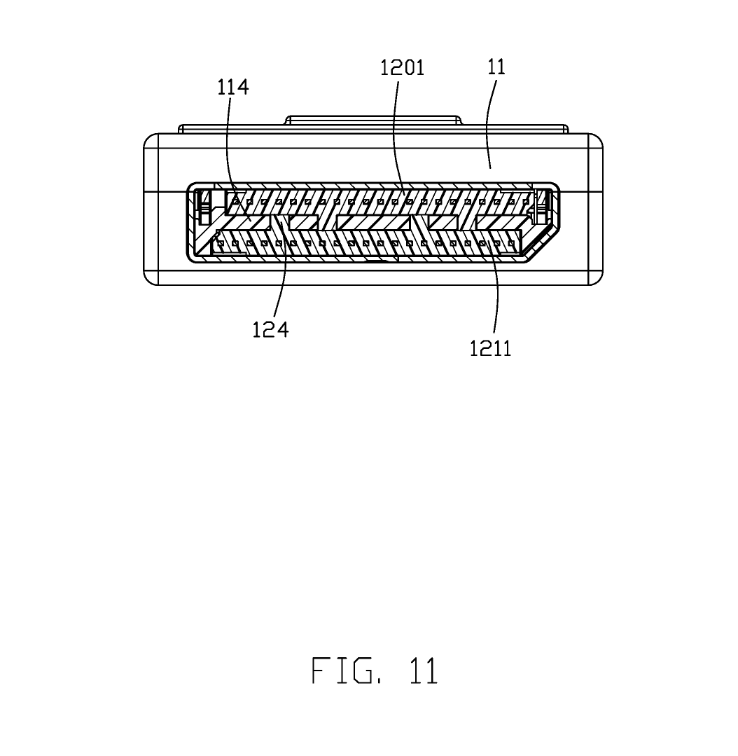

Referring to FIGS. 1 to 11, a plug connector assembly 100 in accordance with the present invention comprises a mating member 1, a printed circuit board 2 electrically connected to the mating member 1, a cable 3 electrically connected with the printed circuit board 2, a latching member 4 assembled on the mating member 1 for latching with a mating connector and an outer case 5 enclosing the mating member 1 and the cable 3. An end of the printed circuit board 2 is connected to the meting member 1 and another end is connected to the cable 3. The cable 3 is a flat structure and includes a plurality of core wires 31.

The mating member 1 includes an insulative housing 11, a contacting module 12 retained in the insulative housing 11 and a metal case 13 enclosing the insulative housing 11. The insulative housing 11 defines a mating surface 111 on a front end thereof, an opposite mounting surface 111, a mating slot 112 inwardly extending from the mating surface 111 and a mounting slot 113 inwardly extending from the mounting surface 111 and communicating with the mating slot 112. The insulative housing 11 further includes a mounting plate 114 defining a plurality of engagement slot 115. The mating slot 112 includes a plurality of first contacting slots 1120 defined on a side thereof and a plurality of second contacting slots 1121 defined on another side thereof. The contacting module 12 is mounted into the insulative housing 11 from the mounting slot 113. The contacting module 12 includes a first contacting module 120 and a second contacting module 121. The first contacting module 120 includes a plurality of first contacts 1200 laterally spaced and a first insulative member 1201 enclosing the first contacts 1200. The second contacting module 121 includes a plurality of second contacts 1210 laterally spaced and a second insulative member 1211 enclosing the second contacts 1210. Both of the first insulative member 1201 and the second insulative member 1211 define a same engagement structure 123, for intervene to engage the first insulative member 1201 with the second insulative member 1211, to combination as a whole and integrally attached to the insulating housing 11.

More specifically, the engagement structure 123 includes a mounting projection 1230 and a mounting hollow 1231. The mounting projection 1230 disposed on the first insulative member 1201 is interference inserted into the corresponding mounting hollow 1231 disposed on the second insulative member 1211, and the mounting projection 1230 disposed on the second insulative member 1211 is interference inserted into the corresponding mounting hollow 1231 disposed on the first insulative member 1201, thus the first contacting module 120 and the second contacting module 121 are fixed and held together. Both of the first insulative member 1201 and the second insulative member 1211 define a pair of spaced engagement structures 123, and the mounting projection 1230 and the mounting hollow 1231 of each engagement structures 123 are connected together.

Both of the first insulative member 1201 and the second insulative member 1211 define a plurality of bumps 124 interference inserted into the corresponding engagement slots 115 of the mounting plate 114, to fix the contacting module 12 on the insulative housing 11. The engagement slots 115 of the mounting plate 114 are define on a same plane, and the bumps 124 of the first and the second insulative member 1201, 1211 are arranged in a row after the first insulative member 1201 is engaged with the second insulative member 1211. In the present embodiment, the first insulative member 1201 and the second insulative member 1211 are of same structure, thus, the number of parts of the plug connector assembly 100 can be reduced and the plug connector assembly 100 can be easy to be assembled, so that the production cost of the plug connector assembly 100 can be reduced.

The metal case 13 surrounds the insulative housing 11, exposing the mating surface 110 and the mounting surface 111 to outside thereof. The metal case 13 defines a pair of through holes 130 spaced on a same side. The latching members 4 are a pair and spaced mounted on the insulative housing 11. Each of the latching member 4 includes a mounting portion 40 forwardly extending, a connecting portion 41 upwardly extending from a rear end of the mounting portion 40, an elastic portion 42 forwardly extending from a top end of the connecting portion 41 and a locking portion 43 disposed on an extremity end of the elastic portion 42. The mounting portion 40 defines a stopping portion 400 downwardly extending there from to limit the depth of the latching member 4 inserted into the insulative housing 11. The elastic portion 420 defines a pressing portion 420 upwardly extending there from, and a holding portion 421 deposed on a front side of the pressing portion 420 and downwardly extending from the pressing portion 420. The holding portion 421 is used for preventing the elastic portion 42 from being overly pressed downwardly. The locking portions 43 are exposed through the corresponding through holes 130 of the metal case 13 to latch with the mating connector.

The outer case 5 includes a first case 51 and a second case 52 engaging with the first case 51 by snap-in way. The outer case 5 defines an operating portion 50 for operating the pressing portion 420 of the latching member 4. Operators presses the operating portion 50 to press the pressing portion 420, and then the pressing portion 420 further drives the locking portion 43 to move toward the inside of the insulative housing 11, and than disengages the latching with the mating connector. The operating portion 50 and the locking portion 43 are disposed on a same side of the mating member 1.

Compared to the prior art, the first insulative member 1201 and the second insulative member 1211 of the plug connector assembly 100 of the present invention are interference engaged with each other to form an integrate assembly and than assembled on the insulative housing 11, thus the first insulative member 1201 and the second insulative member 1211 can be mounted to the insulating housing 11 in a single alignment so that the assembling process is simple and the production cost is reduced.

What is claimed is:

1. A plug connector assembly comprising:
a cable; and
a mating member electrically connected to the cable, the mating member including an insulative housing and a contacting module retained in the insulative housing,
the insulative housing including:
a mating surface defined on a front end thereof;
an opposite mounting surface;
a mating slot inwardly extending from the mating surface, and further including a plurality of first contacting slots arranged on a side thereof and a plurality of second contacting slots arranged on another side thereof; and
a mounting slot communicating with the mating slot and inwardly extending from the mounting surface for inserting the contacting module, the contacting module including:
a first contacting module and a second contacting module, the first contacting module including a plurality of first contacts arranged along a lateral direction and a first insulative member retaining the first contacts, the second contacting module including a plurality of second contacts arranged along the lateral direction and a second insulative member retaining the second contacts; wherein
each of the first and second insulative members includes a same engagement structure, through which the first insulative member and the second insulative member are assembled into a whole by interference arrangement and then inserted into the insulative housing together.

2. The plug connector assembly as claimed in claim 1, wherein the engagement structure includes a mounting projection and a mounting hollow, and the mounting projection disposed on the first insulative member is interference inserted into the corresponding mounting hollow disposed on the second insulative member, and the mounting projection disposed on the second insulative member is interference inserted into the corresponding mounting hollow disposed on the first insulative member.

3. The plug connector assembly as claimed in claim 2, wherein the mounting projection and the mounting hollow are connected with each other.

4. The plug connector assembly as claimed in claim 1, wherein the insulative housing further includes a mounting plate rearwardly extending from the mounting surface, the mounting plate including a plurality of arrangement slots, each of the first insulative member and the second insulative member includes a plurality of bumps interference inserted into the corresponding arrangement slots to fix the contacting module to the insulative housing.

5. The plug connector assembly as claimed in claim 1, wherein the arrangement slots are arranged on a same plane, and the bumps are arranged in a same line after the first insulative member are arranged with the second insulative member.

6. The plug connector assembly as claimed in claim 1, wherein the first contacting module has same structure as the second contacting module.

7. The plug connector assembly as claimed in claim 1, wherein the mating member includes a metal case enclosing the insulative housing.

8. The plug connector assembly as claimed in claim 1, further including an outer case enclosing the mating connector and the cable.

9. The plug connector assembly as claimed in claim 8, further including a pair of latching members assembled on the insulative housing for latching with a mating connector.

10. The plug connector assembly as claimed in claim 9, wherein the outer case includes an operating portion for operating the latching members to disengage from the mating connector.
